(19) United States
(12) Patent Application Publication
(10) Pub. No.: US 2012/0044164 A1
(43) Pub. Date: Feb. 23, 2012

(54) INTERFACE APPARATUS AND METHOD FOR SETTING A CONTROL AREA ON A TOUCH SCREEN

(75) Inventors: Jung Suk KIM, Goyang-si (KR); Hyun Woo MIN, Seoul (KR); Dong Kuk SEO, Seoul (KR); Kyeong Hwan OK, Seoul (KR); Kyoung Young YOON, Seoul (KR); Soo Hyun LEE, Seoul (KR); Woo Kyung JEONG, Seoul (KR)

(73) Assignee: Pantech Co., Ltd., Seoul (KR)

(21) Appl. No.: 13/046,933

(22) Filed: Mar. 14, 2011

(30) Foreign Application Priority Data
Aug. 17, 2010 (KR) 10-2010-0079128

(51) Int. Cl. G06F 3/041

(52) U.S. Cl. 345/173

(57) ABSTRACT

An interfacing apparatus and method for setting a control area of a touch screen. The interface apparatus includes a touch screen, an area setting unit to set a selected area of the touch screen as a control area, a function setting unit to set a function to the control area, and a function executing unit to execute the function at the control area. The interface method includes setting the selected area as a control area, setting a function for the control area, and executing the set function if a touch is sensed on the control area.

### CROSS-REFERENCE TO RELATED APPLICATION

This application claims priority from and the benefit under 35 U.S.C. §119(a) of Korean Patent Application No. 10-2010-0079128, filed on Aug. 17, 2010, which is incorporated by reference for all purposes as if fully set forth herein.

### BACKGROUND

1. Field

The following description relates to an apparatus including a touch screen, and more particularly, to an apparatus and method for setting an area of the touch screen as a control area.

2. Discussion Of The Background

Mobile terminals are being developed as multi-media devices that provide various functions, such as an electronic organizer function, a gaming function, an electronic scheduler function, and the like. As the mobile terminals provide these various supplementary functions, there may be a desire for a user interface that allows users to conveniently access the various supplementary services.

A method of using a touch screen is being focused on among many methods to enable user to conveniently access the supplementary services. A touch screen may be a display device that senses a portion that a user touches with a finger or a touch pen in a shape of a ballpoint pen to execute a command or to move a location of a cursor. The touch screen may operate based on various schemes, such as a pressure sensitive scheme that senses pressure applied on a screen, a capacitive scheme that senses a loss of an electric charge to detect a touch, an infrared ray scheme that senses obstruction of an infrared ray to detect a touch, and the like.

Also, a size of a touch screen included in portable terminals, such as a mobile terminal, an e-book reader, an iPad® or tablet computer, a smart phone, and the like, may be gradually increasing. Accordingly, a user of a portable terminal may not readily control a touch screen with a finger of the same hand that holds the portable terminal.

If the user of the portable terminal uses two hands to operate the portable terminal, the user generally may hold the portable terminal with one hand and controls the touch screen of the terminal with the other hand.

### SUMMARY

Exemplary embodiments of the present invention provide an interfacing apparatus and method for setting a control area of a touch screen.

Additional features of the invention will be set forth in the description which follows, and in part will be apparent from the description, or may be learned by practice of the invention.

Exemplary embodiment of the present invention provide an interface apparatus including a touch screen, an area setting unit to set a selected area of the touch screen as a control area, a function setting unit to set a function to the control area, and a function executing unit to execute the function at the control area.

Exemplary embodiment of the present invention provide an interfacing method including selecting an area of a touch screen, setting the selected area as a control area, setting a function for the control area, and executing the set function if a touch is sensed on the control area.

Exemplary embodiment of the present invention provide an interface apparatus including a touch screen to receive a touch input; an area setting unit to set an area of the touch screen corresponding to the touch input as a control area, which the area setting unit divides the touch screen using a first point-shaped touch input as the touch input; a function setting unit to set a function to the control area; a function executing unit to execute the function at the control area; and an area releasing unit to release the control area if a second point-shaped touch is inputted in a same direction or in an opposite direction as the first point-shaped touch input.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an interface apparatus that sets a control area of a touch screen according to an exemplary embodiment of the invention.

FIG. 2 is a diagram illustrating setting a control area according to an exemplary embodiment of the invention.

FIG. 3 is a diagram illustrating a control area that is set on each area of a touch screen according to an exemplary embodiment of the invention.

FIG. 4 is a flowchart illustrating an interfacing method where an interface apparatus sets a control area according to an exemplary embodiment of the invention.

FIG. 5 is a diagram illustrating providing of a mini map to a control area set by an interface apparatus according to an exemplary embodiment of the invention.

FIG. 6 is a diagram illustrating providing of a mouse pad to a control area set by an interface apparatus according to an exemplary embodiment of the invention.

FIG. 7 is a diagram illustrating providing of a tab function to a control area set by an interface apparatus according to an exemplary embodiment of the invention.

FIG. 8 is a diagram illustrating providing of a keyboard function to a control area set by an interface apparatus according to an exemplary embodiment of the invention.

FIG. 9 is a diagram illustrating providing of a keyboard layout optimizing function to a control area set by an interface apparatus according to an exemplary embodiment of the invention.

FIG. 10 is a diagram illustrating providing of a popup window inputting function to a control area set by an interface apparatus according to an exemplary embodiment of the invention.

FIG. 11 is a diagram illustrating providing of an icon arranging function to a control area set by an interface apparatus according to an exemplary embodiment of the invention.

FIG. 12 is a diagram illustrating providing of a scrollbar function to a control area set by an interface apparatus according to an exemplary embodiment of the invention.

FIG. 13 is a diagram illustrating providing of a clipboard function to a control area set by an interface apparatus according to an exemplary embodiment of the invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

Embodiments of the present invention may provide an apparatus and method for setting an area selected by a user as a control area having a function, and provides an interface corresponding to the function through the set control area.

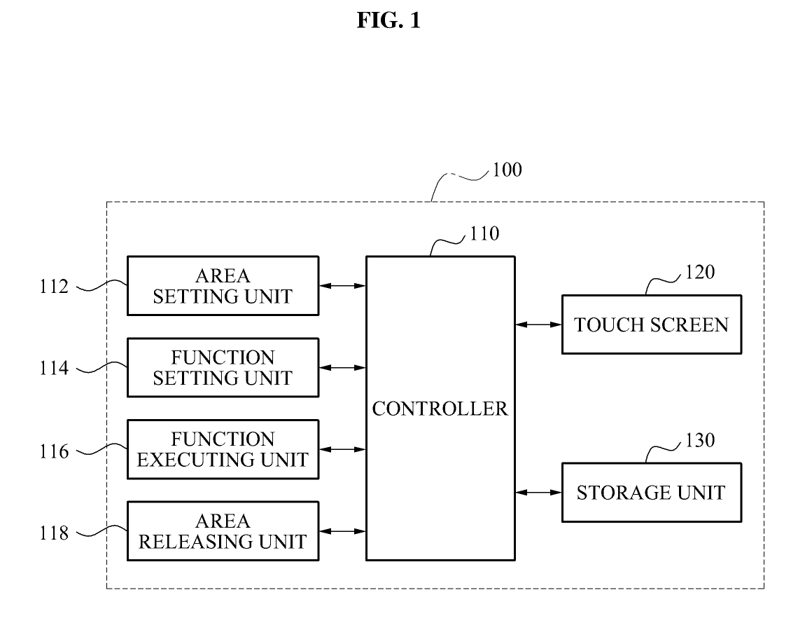

FIG. 1 illustrates an interface apparatus that sets a control area of a touch screen according to an exemplary embodiment of the invention.

As shown in FIG. 1, the interface apparatus 100 includes a controller 110, an area setting unit 112, a function setting unit 114, a function executing unit 116, an area release unit 118, a touch screen 120, and a storage unit 130.

The touch screen 120 may include both an inputting unit and a displaying unit to receive input information and to display the inputted information, using the same screen. In an example, the touch screen 120 may sense a touch on a screen, may recognize an area where the touch is sensed, and may provide the sensed touch area to the controller 110. In addition, the same touch screen 120 may display operational information or an indicator, such as limited numbers and characters, a moving picture, a still picture, and the like generated in response to the received user input. The touch screen 120 may operate based on a pressure sensitive scheme that senses pressure applied on a screen, a capacitive scheme that senses a loss of an electric charge to detect a touch, an infrared ray scheme that senses an obstruction of an infrared ray to detect a touch, and the like.

The storage unit 130 may store an operating system used to control operations of the interface apparatus 100, an application program, and data for storage such as a compressed image file, a moving picture, and the like. In an example, the storage unit 130 may also store information related to a control area set by the area setting unit 112. Further, the storage unit 130 may store a function that may be set by the function setting unit 114 and executed on the control area.

If a control area setting event is generated, a partial area of the touch screen 120 may be selected and the area setting unit 112 may set the selected partial area as a control area. In an example, control area setting event may include a user input, execution of a particular application, a user selecting a particular area of the touch screen to be a control area, or the like.

If a user input to set a control area is received, the area setting unit 112 may determine that the control area setting event is generated. If the control area setting event is determined to have occurred, then the area setting unit 112 may set the selected area selected as the control area.

The area setting unit 112 may set multiple control areas. In an example, the area setting unit 112 may set the multiple control areas by adding a control area one by one, or by adding multiple control areas simultaneously.

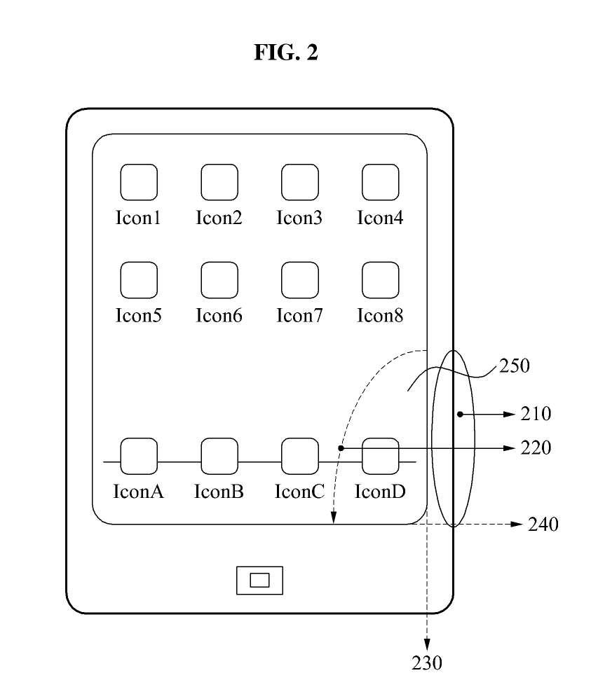

The area setting unit 112 may set the touch screen 120 as the control area according to a reference input that may be received. In an example, the input that may be provided to set a control area may include touching the touch screen 120 at a location and drawing a shape, such as a curve, without releasing the initial touch (“point-shaped touch input”) as illustrated by a curved arrow in FIG. 2. By drawing a curved shape on the touch screen 120 to designate a specific area, this specific area may be set as the control area. Further, if multiple point-shaped touch inputs are inputted, the area setting unit 112 may connect the multiple point-shaped touch inputs to divide the touch screen 120 and may set a smallest area among the divided areas as the control area. Alternatively, the divided areas may be set as the control area by user input, or automatically according to reference conditions. In an example, some applications may require the larger of the divided areas, or other areas to be selected as the control area.

Further, the curved shape that is referenced throughout the application is provided for convenience only and is not limited thereto. The shapes drawn by the touch input may be a curved area, a rectangle, a triangle, a star-shape or any other shape that may be recognized by the touch screen 120.

If the control area is set, the area setting unit 112 may display the set control area to be distinguished from other areas. For example, the area setting unit 112 may display the control area using a dotted-outline, a watermark, a color, or the like.

The function setting unit 114 may set a function of the control area set by the area setting unit 112. More specifically, the function setting unit 114 may set a function corresponding to an application that is being executed on the control area. In an example, the function setting unit 114 may set the function corresponding to the application being executed, a number of control areas, and a location of the control area.

The function setting unit 114 may set a function selected according to a received user's input. Alternatively, the function setting unit 114 may set a function based on meeting a reference condition, such as an execution of a particular application, a number of control areas, and the location of the control area. In an example, executing a specific application may set default functions to the control areas, or designating a control area at a particular location of the touch screen 120 may set a default function to be provided for the control area.

If a touch is sensed on the control area where a function is set, the function executing unit 116 may execute the function corresponding to the touch among functions provided in the control area.

The area releasing unit 118 may release the set control area if a control area release event has occurred. In an example, if multiple control areas are set, the area releasing unit 118 may selectively release the control area according to the control area release event. With respect to the multiple control areas, one or more control areas may be released based on the control area release event. In an example, the control area release event may include user input, closing of an application or a function, change of tasks, shutting down of the system, and the like. More detailed description of how the control area may be released is provided below.

If the control area is set by a point-shaped touch input, in the shape of a curve, the area releasing unit 118 may release the control area by inputting a point-shaped touch input in the same shape inputted to set the control area. If the control area is set by the point-shaped touch in the shape of a curve, the area releasing unit 118 may release the control area by inputting a point-shaped touch in the same direction or an opposite direction to the curved shape inputted to set the control area.

The controller 110 may control operations of the interface apparatus 100 that sets and releases the control area of the touch screen. The controller 110 may perform functions of the area setting unit 112, the function setting unit 114, the function executing unit 116, and the area releasing unit 118. The controller 110, the area setting unit 112, the function setting unit 114, the function executing unit 116, and the area releasing unit 118 are separately illustrated for ease of description of each of the functions. If embodiments are embodied as a product, the controller 110 may be configured to perform a function of one or more of above described units. Also, the controller 110 may be configured to perform a part of functions of one or more of the area setting unit 112, the function setting unit 114, the function executing unit 116, and the area releasing unit 118.

FIG. 2 illustrates setting a control area according to an exemplary embodiment of the invention. Referring to FIG. 2, if a point-shaped touch 220 in the shape of a curve is inputted, the area setting unit 112 may set a smallest area among areas divided by the point-shaped touch 220 in the shape of a curve as the control area. More specifically, the point-shaped touch 220 as illustrated is located between a right outline 230 and a bottom outline 240 and is started from a location 210. Further, since the smallest area among the divided area in FIG. 2 is the area including “IconD”, this area will be set as the control area.

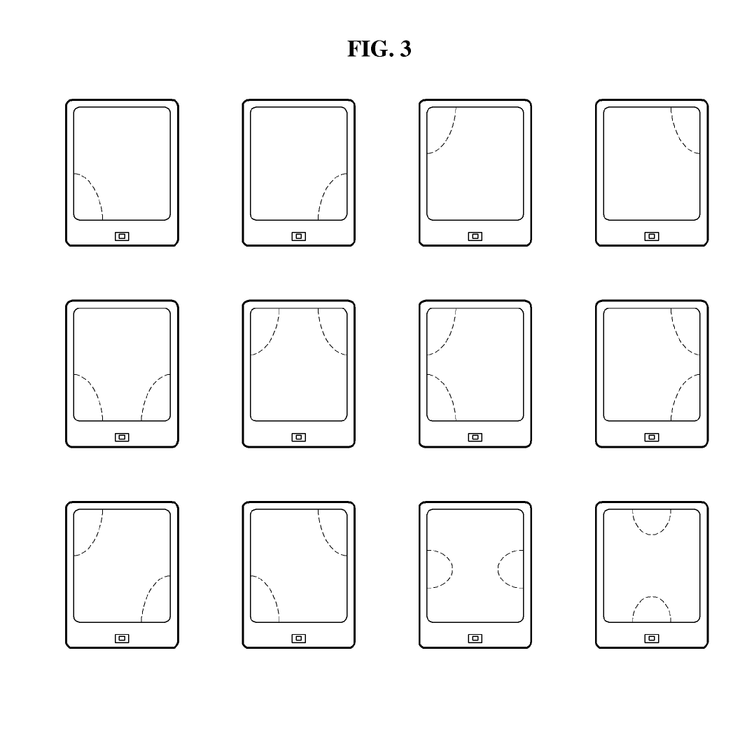

FIG. 3 illustrates a control area that is set on each area of a touch screen according to an exemplary embodiment of the invention. Referring to FIG. 3, a control area may be marked by a dotted-outline. In an example, a single control area or multiple control areas may be set. Referring to FIG. 3, an area that the user controls with a hand holding a terminal is selected as the control area and thus, the control area may be arranged on an edge or a boarder of the touch screen.

An interfacing method that sets a control area of a touch screen is described below.

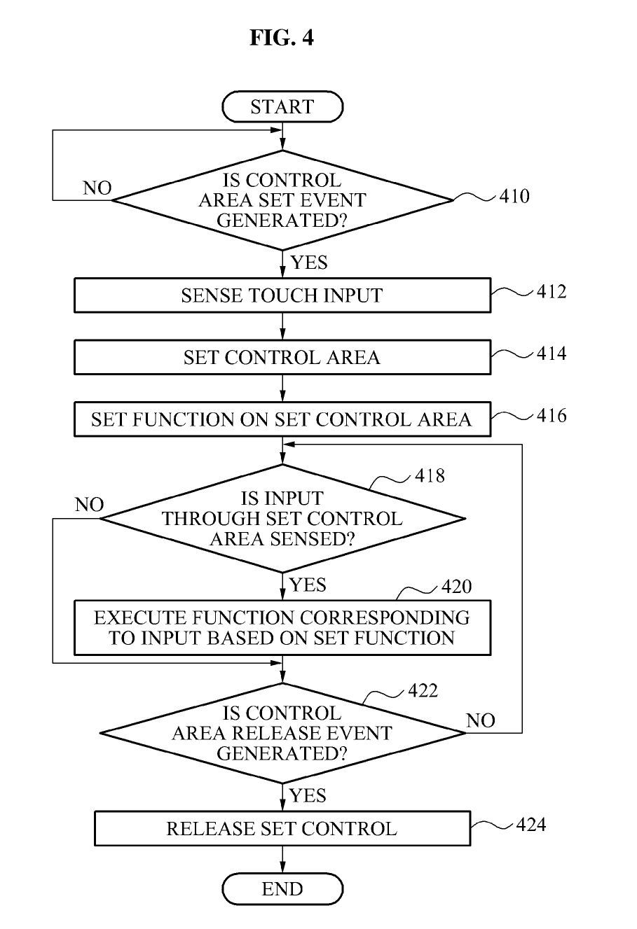

FIG. 4 illustrates an interfacing method for setting a control area according to an exemplary embodiment of the invention. For convenience, FIG. 4 will be described as if the method was performed by the interface apparatus 100 described above. However, the method is not limited as such.

Referring to FIG. 4, the interface apparatus 100 may determine whether a control area setting event is generated in operation 410. If the control area setting event is generated, the interface apparatus 100 may further sense a touch input on the touch screen 120 in operation 412 and thus, a partial area of the touch screen 120 is selected as an area that may be available for selection to be set as a control area.

The interface apparatus 100 may set the at least one of the selected areas as control area in operation 414.

The interface apparatus 100 may set a function on the at least one control area in operation 416. In an example, the set function may be a function corresponding to an application that is being executed or may be a function selected by a user.

The interface apparatus 100 may sense whether an input is received through the set control area in operation 418. If the input is not sensed, the interface apparatus 100 may proceed with operation 422.

Alternatively, if the input is sensed to be received through the set control area, the interface apparatus 100 may execute a function corresponding to the input. In an example, the corresponding function that correlates to interface apparatus 100 may be based on the function set in the control area.

The interface apparatus 100 may determine whether a control area release event is generated in operation 422.

If the control area release event is not generated, the interface apparatus 100 returns to operation 418.

Alternatively, if the control area release event is generated, the interface apparatus 100 may release the set control area in operation 424.

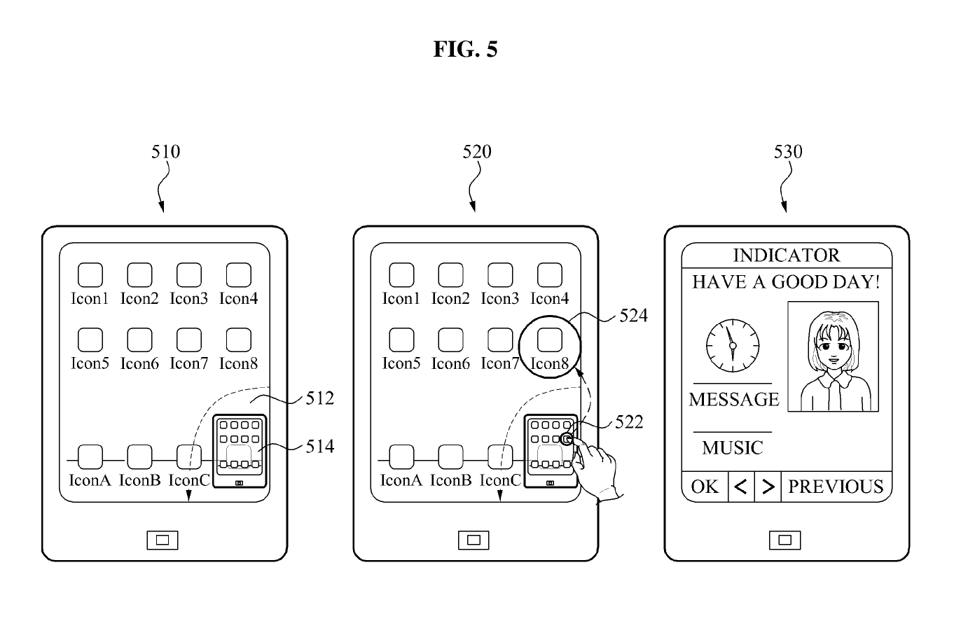

FIG. 5 illustrates providing of a mini map to a control area set by the interface apparatus according to an exemplary embodiment of the invention.

Referring to FIG. 5, if the control area 512 is set in operation 510, the interface apparatus 100 may output, on the control area 512, a mini-map 514 with respect to an image that is being displayed. If a touch on an icon 522 of the mini-map is sensed, the interface apparatus 100 may select an icon 524 corresponding to the icon 522 of the mini-map 514. The interface apparatus 100 may execute an application corresponding to the icon 524 in operation 530.

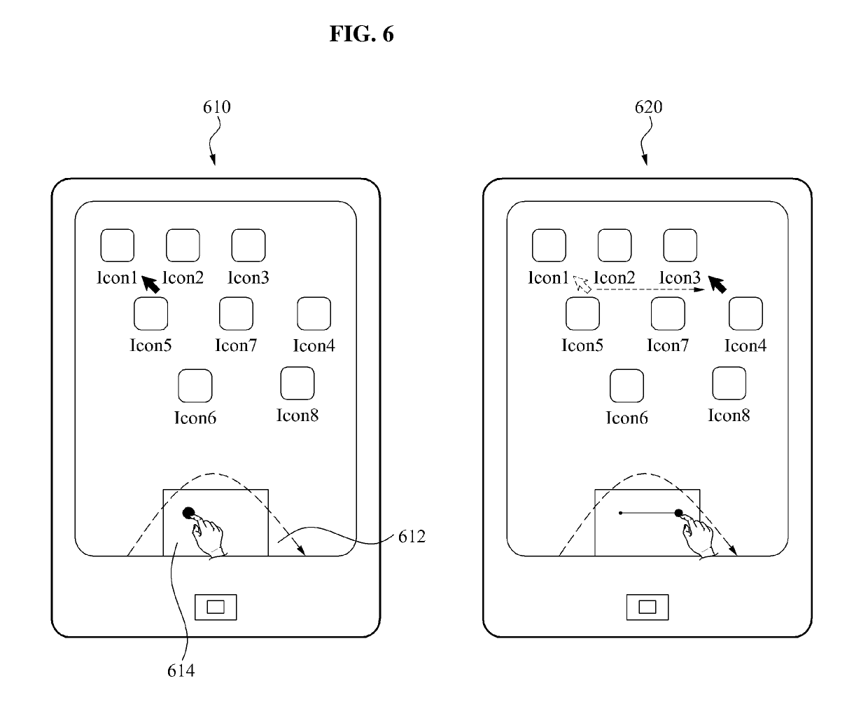

FIG. 6 illustrates providing of a mouse pad to a control area set by the interface apparatus according to an exemplary embodiment of the invention.

Referring to FIG. 6, if the control area 612 is set in operation 610, the interface apparatus 100 may apply a function of a control mechanism that moves the pointer or a cursor (“mouse pad”) 614, similar to touch-pads on laptops, to the control area 612. In an example, the function of the mouse pad 614 may be applied as follows. The interface apparatus 100 may calculate a ratio of a main screen, set the mouse pad 614 on the control area 612 occupying an area corresponding to the ratio of the main screen, and calculate a corresponding location of the main area. Further, if a user input is received on the control area 612, a corresponding action may be provided. For example, if a touch input is received as a user drawing a line across the mouse pad 614 in operation 620, the interface apparatus 100 may move a corresponding cursor of a main screen over a corresponding distance as illustrated by the moved cursor in operation 620.

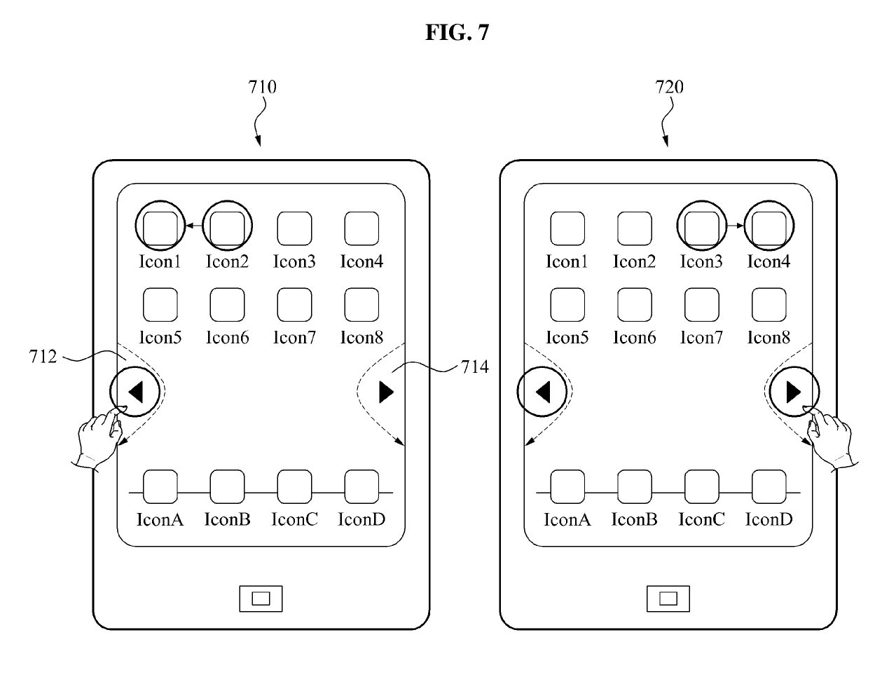

FIG. 7 illustrates providing of a tab function to a control area set by an interface apparatus according to an exemplary embodiment of the invention.

Referring to FIG. 7, if control area 712 and control area 714 are set in operation 710, the interface apparatus 100 applies a tab function to the control area 712 and control area 714. If the control area 712 and control area 714 are set on left and right sides of the touch screen 120, the tab function may operate the left control area 712 with a left navigation key and may operate the right control area 714 with a right navigation key, thereby allowing movement of a page and an icon. In an example, if a touch on the right control area 714 is sensed in operation 720, the interface apparatus 100 moves a cursor from “Icon3” to the right direction, where “Icon4” is located. Alternatively, if touch on the left control area 712 is sensed in operation 710, the interface apparatus 100 moves from the currently selected “Icon2” to the left direction, where “Icon1” is located. Further, this movement may be applied to electronic books to move from one page to the next or in other similar applications. Also, although not illustrated, the control areas may be provided in other areas on the touch screen 120 in various directions, such as up, down, diagonal or the like.

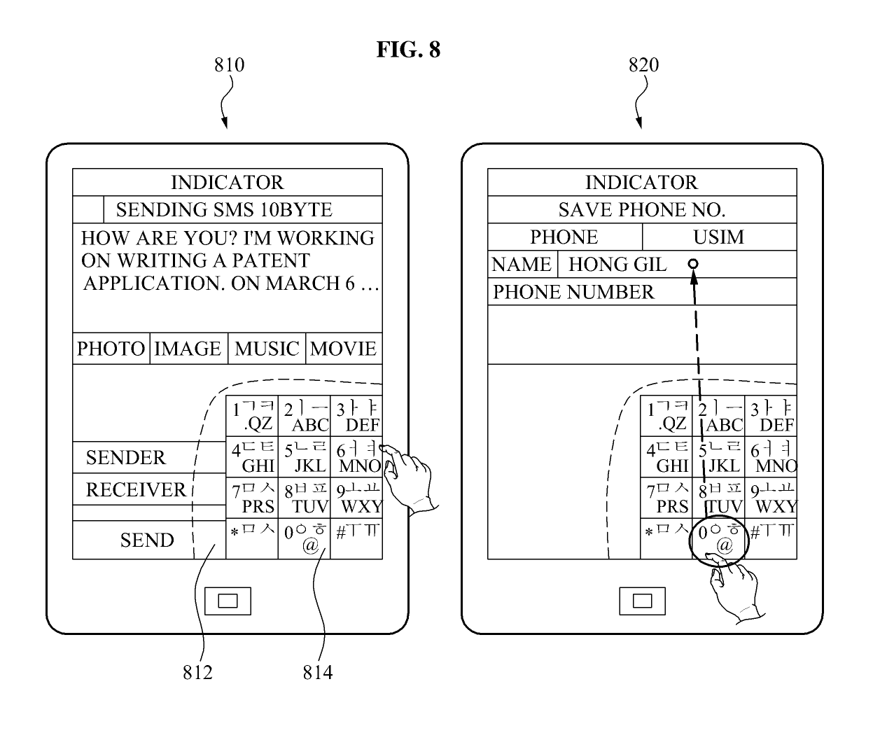

FIG. 8 illustrates providing of a keyboard function to a control area set by an interface apparatus according to an exemplary embodiment of the invention.

Referring to FIG. 8, if the control area 812 is set in operation 810, the interface apparatus 100 outputs a keyboard 814 to the control area 812. If a key is inputted through the keyboard 814, the interface apparatus 100 may input a corresponding character in operation 820.

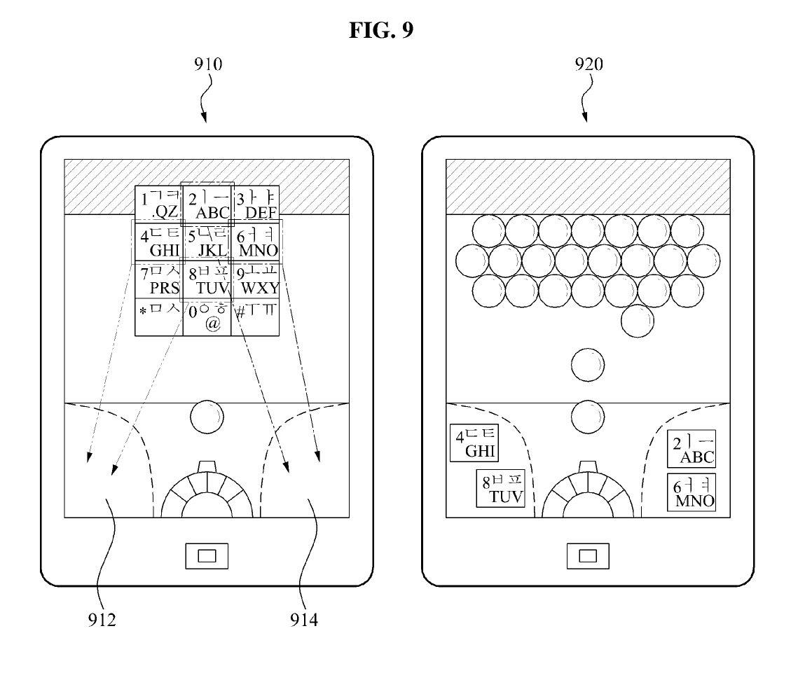

FIG. 9 illustrates providing of a keyboard layout optimizing function to a control area set by the interface apparatus according to an exemplary embodiment of the invention.

Referring to FIG. 9, if control area 912 and control area 914 are set in operation 910, the interface apparatus 100 may lay out either a reference keyboard or a keyboard selected by the user on the control area 912 and control area 914. If a keyboard located in the control area 912 or control area 914 is inputted, the interface apparatus 100 may perform an event corresponding to the inputted keyboard in operation 920.

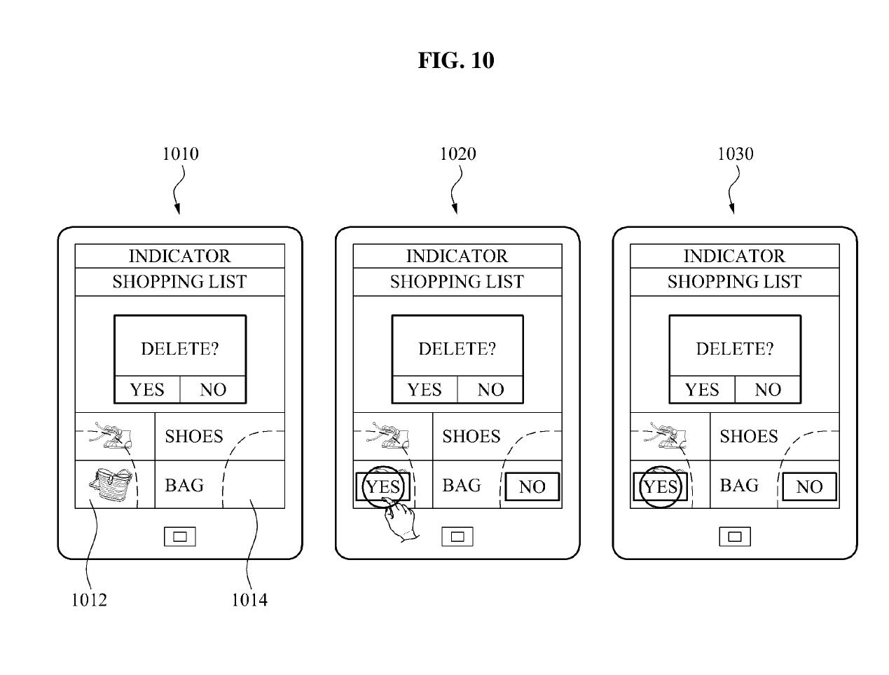

FIG. 10 illustrates providing of a popup window inputting function to a control area set by the interface apparatus according to an exemplary embodiment of the invention.

Referring to FIG. 10, if control area 1012 and control area 1014 are set in operation 1010, the interface apparatus 100 may set a left control area 1012 to be mapped to ‘yes’ in a popup window and may set a right control area 1014 to be mapped to ‘no’ in the popup window.

For example, if a touch on the left control area 1012 is sensed in operation 1020, the interface apparatus 100 activates an event of ‘yes’ in the mapped popup window to perform a deletion corresponding to the event of the popup window in operation 1030.

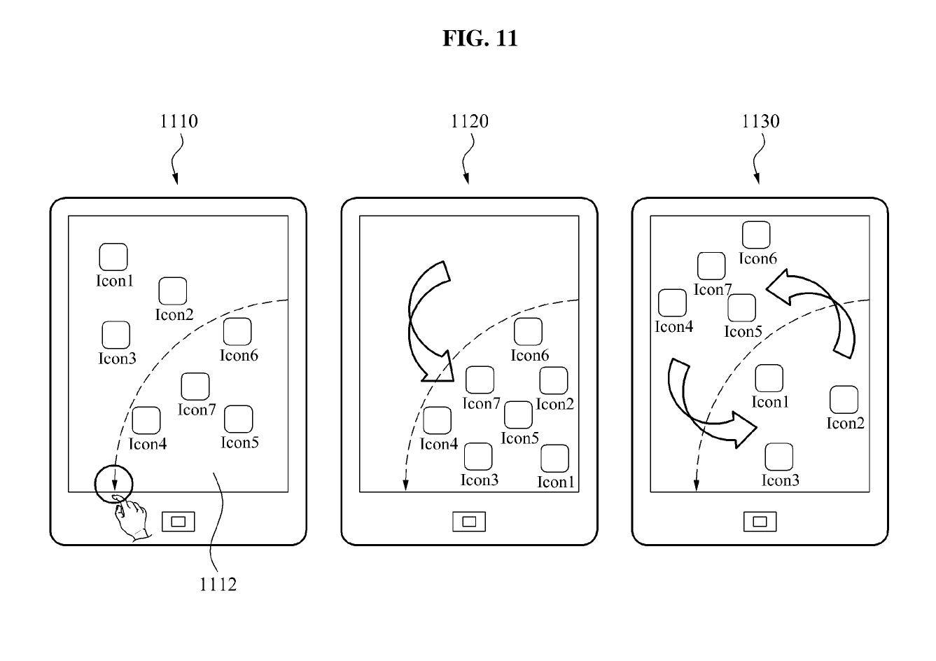

FIG. 11 illustrates providing of an icon arranging function to a control area set by the interface apparatus according to an exemplary embodiment of the invention.

Referring to FIG. 11, if a control area 1112 is set in operation 1110, the interface apparatus 100 moves all icons located outside the control area 1112 to inside the control area 1112 and arranges the moved icons inside the control area 1112 in operation 1120, or exchanges locations of icons located outside the control area 1112 with locations of icons located inside the control area 1112 in operation 1130.

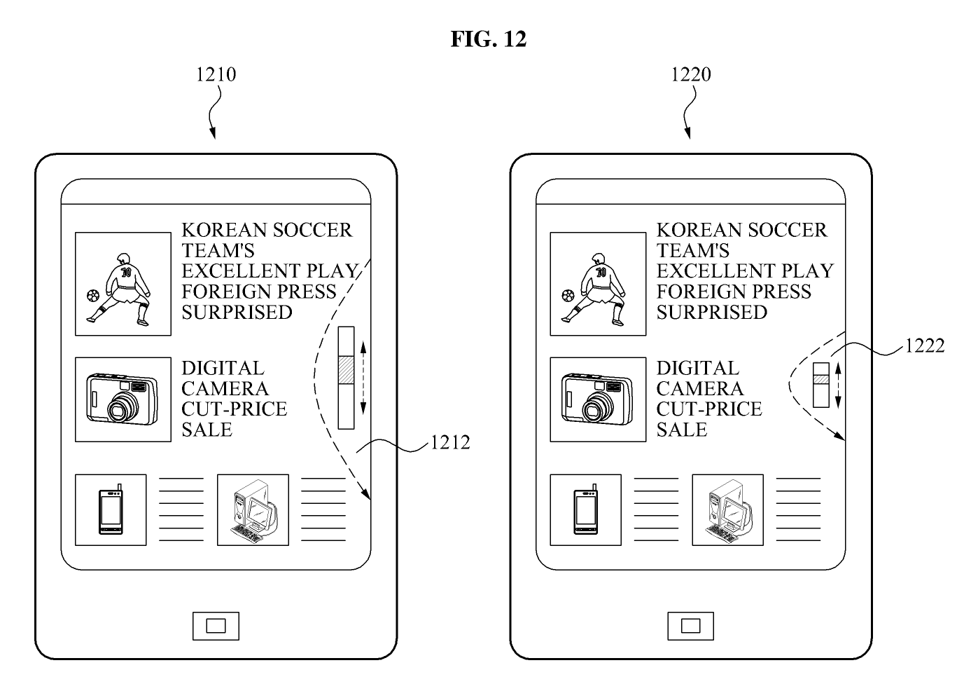

FIG. 12 illustrates providing of a scrollbar function to a control area set by the interface apparatus according to an exemplary embodiment of the invention.

Referring to FIG. 12, if a control area, such as a control area 1212 or a control area 1222, is set as illustrated in operation 1210 or operation 1220, the interface apparatus 100 generates a scrollbar based on a size of the set control area and moves a displayed screen according to a movement of the scrollbar. In this example, a scrolling speed of the scrollbar may be adjusted based on the size of the scrollbar and thus, the scrolling speed may be adjusted based on the size of the control area.

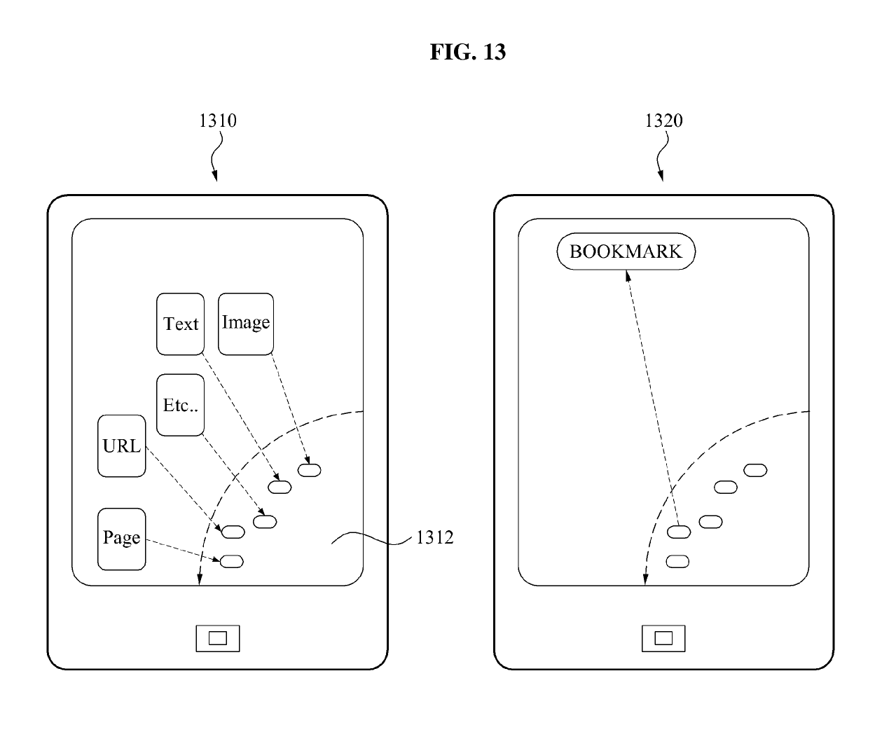

FIG. 13 illustrates providing of a clipboard function to a control area set by an interface apparatus according to an exemplary embodiment of the invention.

Referring to FIG. 13, if a control area 1312 is set in operation 1310, the interface apparatus 100 may apply a clipboard function to the control area 1312. The clipboard function may display a copied or cut image or text on the control area 1312, and may allow a user to drag the copied or cut image or text displayed in the control area 1312 and paste the dragged image or text. In another example, in operation 1320, the interface apparatus 100 drags a URL displayed on the control area 1312 and registers the dragged URL as a bookmark.

In addition to the exemplary embodiments described with reference to FIG. 5, FIG. 6, FIG. 7, FIG. 8, FIG. 9, FIG. 10, FIG. 11, FIG. 12, and FIG. 13, various other embodiments are possible.

For example, without limitation, an interface apparatus may provide a gesture function or a multi-tasking function to a set control area. In this example, if a reference gesture is inputted to the set control area, the gesture function may execute an application or an operation corresponding to the inputted gesture. More specifically, if the control area is set, the multi-tasking function may display applications that are being executed as a multi-task, and if an application is selected among the multi-tasked applications displayed on the control area, the multi-tasking function may enable the user to switch to the selected application.

According to exemplary embodiments of the present invention, there is provided an interfacing apparatus and method that may set an area as a control area having a new function, and may provide a corresponding interface through the set control area. As the size of a touch screen continues to increase, the interfacing apparatus and method may provide the control area to be more freely set by the user to enable the user to control an area that may be difficult to be controlled by a hand holding a terminal and not fully reaching the touch screen.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An interface apparatus, comprising:
a touch screen;
an area setting unit to set a selected area of the touch screen as a control area;
a function setting unit to set a function to the control area; and
a function executing unit to execute the function at the control area.

2. The interface apparatus of claim 1, wherein the area setting unit divides the touch screen into a first divided area and a second divided area using a point-shaped touch input, and sets a smaller area of the first divided area and the second divided area as the control area, and wherein the point-shaped touch is inputted by touching and dragging the touched point without releasing its contact with the touch screen to divide the touch screen.

3. The interface apparatus of claim 1, wherein the area setting unit displays the control area to be distinguished from other areas.

4. The interface apparatus of claim 1, wherein the area setting unit sets multiple control areas.

5. The interface apparatus of claim 1, wherein the function corresponds to an application that is being executed or corresponds to a received user input on the control area

6. The interface apparatus of claim 1, wherein the function corresponds to at least one of an application being executed, a number of set control areas, and a location of the set control area.

7. The interface apparatus of claim 1, further comprising:
an area releasing unit to release the control area if a control area release event is generated.

8. The interface apparatus of claim 7, wherein the area releasing unit releases the control area from among multiple control areas.

9. The interface apparatus of claim 7, wherein the area releasing unit releases the control area if a point-shaped touch is inputted in a same direction or in an opposite direction as a point-shaped touch input used to set the control area.

10. The interface apparatus of claim 1, wherein the function provided by the control area includes at least one of a mini-map function, a mouse pad function, a tab function, a keyboard function, a keyboard layout optimizing function, a popup window inputting function, an icon arranging function, a scrollbar function, a clipboard function, a gesture function, and a multi-tasking function.

11. An interface method, comprising:
selecting an area of a touch screen;
setting the selected area as a control area;
setting a function for the control area; and
executing the set function if a touch is sensed on the control area.

12. The interface method of claim 11, wherein setting the control area comprises dividing the touch screen into a first divided area and a second divided area using a point-shaped touch input and setting a smaller area of the first divided area and the second divided area as the control area, and wherein the point-shaped touch is inputted by touching and dragging the touched point without releasing its contact with the touch screen to divide the touch screen.

13. The interface method of claim 11, wherein setting the control area comprises displaying the control area to be distinguished from other areas.

14. The interface method of claim 11, wherein setting the control area comprises setting multiple control areas.

15. The interface apparatus of claim 11, wherein the function corresponding to an application that is being executed or corresponding to a received user input on the control area

16. The interface method of claim 11, wherein the function corresponding to at least one of an application being executed, a number of set control areas, and a location of the set control area.

17. The interface method of claim 11, further comprising:
releasing the control area if a control area release event is generated.

18. The interface method of claim 17, wherein releasing comprises releasing the control area from among the multiple control areas.

19. The interface method of claim 12, wherein the releasing the control area comprises releasing the control area if a point-shaped touch is inputted in a same direction or in an opposite direction as a point-shaped touch input used to set the control area.

20. The interface method of claim 11, wherein the function provided by the control area includes at least one of a mini-map function, a mouse pad function, a tab function, a keyboard function, a keyboard layout optimizing function, a popup window inputting function, an icon arranging function, a scrollbar function, a clipboard function, a gesture function, and a multi-tasking function.

21. An interface apparatus, comprising:
a touch screen to receive a touch input;
an area setting unit to set an area of the touch screen corresponding to the touch input as a control area, wherein the area setting unit divides the touch screen using a first point-shaped touch input as the touch input;
a function setting unit to set a function to the control area;
a function executing unit to execute the function at the control area; and
an area releasing unit to release the control area if a second point-shaped touch is inputted in a same direction or in an opposite direction as the first point-shaped touch input.
